(19) United States
(12) Patent Application Publication
(10) Pub. No.: US 2006/0024491 A1
(43) Pub. Date: Feb. 2, 2006

(54) Optical effect films with customized central layer

(75) Inventor: Daniel Graney, LaGrangeville, NY (US)

Correspondence Address: Engelhard Corporation, 101 Wood Avenue, P.O. Box 770, Iselin, NJ, 08830, US

(73) Assignee: ENGELHARD CORPORATION

(21) Appl. No.: 11/188,499

(22) Filed: Jul. 25, 2005

Related U.S. Application Data
(60) Provisional application No. 60/591,399, filed on Jul. 27, 2004.

(51) Int. Cl. B32B 5/16

(52) U.S. Cl. 428/323

(57) ABSTRACT

An optical effect thermoplastic resinous laminate film of very thin layers, a substantially uniform thickness, and being generally parallel, and wherein the contiguous adjacent layers differ in refractive index. The film containing an interior layer being parallel to the contiguous adjacent layers but being different from the contiguous adjacent layers so as to provide a change in the optical or physical properties of the film.

### CROSS REFERENCE TO RELATED APPLICATION

This application claims the benefit of prior U.S. provisional application Ser. No. 60/591,399 filed Jul. 27, 2004.

### BACKGROUND OF THE INVENTION

The present invention relates to multilayer coextruded light-reflecting films which have a narrow reflection band due to light interference. When the reflection band occurs within the range of visible wavelength, the film is iridescent. Similarly, when the reflection band falls outside the range of visible wavelength, the film is either ultraviolet or infrared reflecting. Such multilayer films and methods by which they can be produced are known in the art. They are described, for instance, in U.S. Pat. Nos. 3,565,985, 3,759,657, 3,773,882 and 3,801,429 and other patents.

The multilayer films are composed of a plurality of generally parallel layers of transparent thermoplastic resinous material in which the contiguous adjacent layers are of diverse resinous material whose index of refraction differs by at least about 0.03. The film contains at least 10 layers and more usually at least 35 layers and, preferably, at least about 70 layers.

The individual layers of the film are very thin, usually in the range of about 30 to 500 nm, preferably about 50-400 nm, which causes constructive interference in light waves reflected from the many interfaces. Depending on the layer thickness and the refractive index of the polymers, one dominant wavelength band is reflected and the remaining light is transmitted through the film. The reflected wavelength is proportional to the sum of the optical thickness of a pair of layers.

The quantity of the reflected light (reflectance) and the color intensity depend on the difference between the two refractive indices, on the ratio of optical thicknesses of the layers, on the number of layers and on the uniformity of the thickness. If the refractive indices are the same, there is no reflection at all from the interfaces between the layers. In multilayer iridescent films, the refractive indices of contiguous adjacent layers differ by at least 0.03 and preferably by at least 0.06 or more. For first order reflections, reflectance is highest when the optical thicknesses of the layers are equal, although suitably high reflectances can be achieved when the ratio of the two optical thicknesses falls between 5:95 and 95:5. Distinct color reflections are obtained with as few as 10 layers. However, for maximum color intensity it is desired to have between 35 and 1,000 or even more layers. High color intensity is associated with a reflection band which is relatively narrow and which has high reflectance at its peak. It should be recognized that although the term “color intensity” has been used here for convenience, the same considerations apply to the invisible reflection in the ultraviolet and infrared ranges.

The multilayer films can be made by a chill-roll casting technique using a conventional single manifold flat film die in combination with a feedblock which collects the melts from each of two or more extruders and arranges them into the desired layer pattern. The number of layers and their thickness distribution can be changed by inserting a different feedblock module. Usually, the outermost layer or layers on each side of the sheet are thicker than the other layers. This thicker skin may consist of one of the components which makes up the optical core; may be a different polymer which is utilized to impart desirable mechanical, heat sealing, or other properties; or may be a combination of these.

Some recent developments in the iridescent film are described in U.S. Pat. Nos. Re. 31,780; 4,937,134; and 5,089,318. U.S. Pat. No. Re. 31,780 describes using a thermoplastic terephthalate polyester or copolyester resin as the high refractive index component of the system. Formation of elastomeric interference films are described in U.S. Pat. No. 4,937,134 in which all of the resinous materials are certain thermoplastic polyurethanes, polyester block amides or flexible copolyesters. U.S. Pat. No. 5,089,318 discloses improved multilayer light-reflecting transparent thermoplastic resinous film of at least 10 generally parallel layers in which the contiguous adjacent layers are of diverse transparent thermoplastic resinous material differing in refractive index by at least about 0.03 and at least one of the resinous materials being an engineering thermoplastic elastomer resin.

Conventional multi-nanolayered films designed for optical and decorative purposes possess uninterrupted layering of the color-generating polymer pairs. This design maximizes the transparency of the structure to facilitate constructive interference of incident light throughout the optical core. The specific wavelengths which are reflected and the remaining electromagnetic radiation which is transmitted is a function of the F-ratio for a particular polymer pair and controlled by the relative thickness of the respective layers.

For certain applications, it is desirable to maximize the reflection of the targeted wavelengths and minimize any transmission effects. This can be demonstrated with a lamination of a typical iridescent film onto a black substrate, whereupon the reflection colors are maximized. The effect, however, is limited to one surface. To attain identical effects on both surfaces would require another film being laminated to that surface, increasing the overall cost and complexity for this effect.

### SUMMARY OF THE INVENTION

The object of the invention is to create novel iridescent/optical effect films comprised of multiple polymeric nanolayers for iridescent color generation and a central layer of sufficient dimension containing specific ingredients to impart a desired level of opacity, color effect, light diffusing properties, physical properties, or mixtures of such effects and/or properties.

A specially designed feedblock can be used to separate the optical core of a conventional iridescent film and facilitate insertion of a distinct polymer stream to create a new effect. The inserted layer, which is sandwiched between two stacked layers of alternating pairs of polymers which generate the iridescent effect, can contain one or more additives which can be tailored to augment and modify the usual optical effect or provide enhanced physical properties to the film. The new effect can result in films made to be identical whether viewed from the top surface or the bottom surface independent of viewing background.

### DETAILED DESCRIPTION OF THE INVENTION

Multilayer coextruded iridescent film per se is known in the art. It is described in U.S. Pat. No. Re 31,780 to Cooper, Shetty and Pinksy and U.S. Pat. Nos. 5,089,318 and 5,451,449, both to Shetty and Cooper, all of which are incorporated herein by reference, and in other patents. The iridescent film is, as there described, a transparent thermoplastic resinous coextruded laminated film of at least 10 very thin layers, preferably at least about 35 layers and more preferably at least about 70 layers, each of which is usually in the range of about 30-500 nm and more preferably about 50-400 nm, with the layers being generally parallel and the contiguous adjacent layers being of different transparent thermoplastic resinous materials differing in refractive index by at least about 0.03, and more preferably, at least about 0.06. The outermost layers of the film constituting a skin, when present, are each at least about 5% of the total thickness of the film.

Any of the thermoplastic resinous material used to prepare iridescent film heretofore can be used in the present invention as long as the individual materials have the characteristics set forth above and likewise, the combination of selected resinous materials has the characteristics detailed above. Useful polymers for the film layers include polyesters, polyacrylates, polyethylene vinyl acetate, polyolefins, and polystryenes. For example, polyesters include polyethylene terephthalate, polybutylene terephthalate, glycol modified polyethylene terephthalate made from ethylene glycol, and cyclohexamedimethanol characterized by a refractive index of about 1.55 to 1.61, and polyethylene naphthalate as disclosed in commonly assigned U.S. Pat. No. 6,475,608, incorporated herein by reference. A useful polyacrylate includes polymethyl methacrylate. Non-limiting examples of useful films include alternating layers of polybutylene terephthalate (hereinafter “PBT”) and polymethyl methacrylate (hereinafter “PMMA”); alternating layers of polyethylene terephthalate (PET) and polymethyl methacrylate; alternating layers of polystyrene and ethylene vinyl acetate (hereinafter “EVA”); alternating layers of polyethylene naphthalate and polymethyl methacrylate; alternating layers of polyethylene terephthalate and ethylene methyl acrylate (hereinafter “EMA”); and alternating layers of polyethylene naphthalate and polymethyl methacrylate. The layers may be colored or tinted as taught by commonly assigned U.S. Pat. No. 5,451,449. Table 1 below sets forth additional polymers which can be used to form the films of this invention.

TABLE 1

| | APPROXIMATE |
|---|---|
| POLYMER NAME | REF INDEX |
| Poly(tetrafluoroethylene-co-hexafluoropropylene) | 1.338 |
| Poly(pentadecafluorooctyl acrylate) | 1.339 |
| Poly(tetrafluoro-3-(heptafluoropropoxy)propyl | 1.346 |
| acrylate) | |
| Poly(tetrafluoro-3-(pentafluoroethoxy)propyl acrylate | 1.348 |
| Poly(tetrafluoroethylene) | 1.35 (−1.38) |
| Poly(undecafluorohexyl acrylate) | 1.356 |
| Poly(nonafluoropentyl acrylate) | 1.360 |
| Poly(tetrafluoro-3-(trifluoromethoxy)propyl acrylate) | 1.360 |
| Poly(pentafluorovinyl propionate) | 1.364 |
| Poly(heptafluorobutyl acrylate) | 1.367 |
| Poly(trifluorovinyl acetate) | 1.375 |
| Poly(octafluoropentyl acrylate) | 1.380 |
| Poly(pentafluoropropyl acrylate) | 1.385 |
| Poly(2-(heptafluorobutoxy)ethyl acrylate) | 1.390 |
| Poly(2,2,3,4,4,4-hexafluorobutyl acrylate) | 1.392 |
| Poly(trifluoroethyl acrylate) | 1.407 |
| Poly(2-(1,1,2,2-tetrafluoroethoxy)ethyl acrylate) | 1.412 |
| Poly(trifluoroisopropyl methacrylate) | 1.4177 |
| Poly(2,2,2-trifluoro-1-methylethyl methacrylate) | 1.4185 |
| Poly(2-(trifluoroethyoxy)ethyl acrylate) | 1.419 |
| Poly(trifluorochloroethylene) | 1.42-1.43 |
| Poly(vinylidene fluoride) | 1.42 |
| Poly(dimethylsilylene(poly(dimethyl siloxane)) | 1.43 |
| Poly(trifluoroethyl methacrylate) | 1.437 |
| Poly(oxypropylene) | 1.4495 |
| Polylactide | 1.45 |
| Poly(vinyl isobutyl ether) | 1.4507 |
| Poly(vinyl.ethyl ether) | 1.4540 |
| Poly(oxyethylene) | 1.4563 |
| Poly(vinyl butyl ether) | 1.4563 |
| Poly(vinyl pentyl ether) | 1.4581 |
| Poly(vinyl hexy ether) | 1.4591 |
| Poly(4-methyl-1-pentene) | 1.459-1.465 |
| Cellulose acetate butyrate | 1.46-1.49 |
| Poly(4-fluoro-2-trifluoromethylstyrene) | 1.46 |
| Poly(vinyl octyl ether) | 1.4613 |
| Poly(vinyl 2-ethylhexyl ether) | 1.4626 |
| Poly(vinyl decyl ether) | 1.4628 |
| Poly(2-methoxyethyl acrylate) | 1.463 |
| Poly(butyl acrylate) | 1.4631 |
| Poly(butyl acrylate) | 1.466 |
| Poly(tert-butyl methacrylate) | 1.4638 |
| Poly(vinyl dodecyl ether) | 1.4640 |
| Poly(3-ethoxypropyl acrylate) | 1.465 |
| Poly(oxycarbonyl tetramethylene) | 1.465 |
| Poly(vinyl propionate) | 1.4665 |
| Poly(vinyl acetate) | 1.4665 |
| Poly(vinyl methyl ether) | 1.467 |
| Poly(ethyl acrylate) | 1.4685 |
| Poly(ethylene-co-vinyl acetate) | 1.47-1.50 |
| (30%-20% vinyl acetate) | |
| Cellulose proprionate | 1.47-1.49 |
| Cellulose acetate propionate | 1.47 |
| Benzyl cellulose | 1.47-1.58 |
| Phenol-formaldehyde resins | 1.47-1.70 |
| Cellulose triacetate | 1.47-1.48 |
| Poly(vinyl sec-butyl ether) (isotactic) | 1.4700 |
| Poly(3-methoxypropyl acrylate) | 1.471 |
| Poly(2-ethoxyethyl acrylate) | 1.471 |
| Poly(methyl acrylate) | 1.472-1.480 |
| Poly(isopropyl methacrylate) | 1.4728 |
| Poly(1-decene) | 1.4730 |
| Poly(propylene) (atactic, density 0.8575 g/cm.sup.3) | 1.4735 |
| Poly(vinyl sec-butyl ether)(isotactic | 1.4740 |
| Poly(dodecyl methacrylate) | 1.4740 |
| Poly(oxyethyleneoxysuccinoyl) (poly(ethylene | 1.4744 |
| succinate)) | |
| Poly(teradecyl methacrylate) | 1.4746 |
| Poly(ethylene-co-propylene) (EPR-rubber) | 1.4748-1.48 |
| Poly(hexadecyl methacrylate) | 1.4750 |
| Poly(vinyl formate) | 1.4757 |
| Poly(2-fluoroethyl methacrylate) | 1.4768 |
| Poly(isobutyl methacrylate) | 1.477 |
| Ethyl cellulose | 1.479 |
| Poly(vinyl acetal) | 1.48-1.50 |
| Cellulose acetate | 1.48-1.50 |
| Cellulose tripropionate | 1.48-1.49 |
| Poly(oxymethylene) | 1.48 |
| Poly(vinyl butyral) | 1.48-1.49 |
| Poly(n-hexyl methacrylate) | 1.4813 |
| Poly(n-butyl methacrylate) | 1.483 |
| Poly(ethylidene dimethacrylate) | 1.4831 |
| Poly(2-ethoxyethyl methacrylate) | 1.4833 |
| Poly(oxyethyleneoxymaleoyl) (poly(ethylene maleate)) | 1.4840 |
| Poly(n-propyl methacrylate) | 1.484 |
| Poly(3,3,5-trimethylcyclohexyl methacrylate) | 1.485 |
| Poly(ethyl methacrylate) | 1.485 |
| Poly(2-nitro-2-methylpropyl methacrylate) | 1.4868 |
| Poly(triethylcarbinyl methacrylate) | |
| Poly(1,1-diethyipropyl methacrylate) | 1.4889 |
| Poly(methyl methacrylate) | 1.4893 |
| Poly(2-decyl-1,3-butadiene) | 1.4899 |
| Polymethylmethacrylate (PMMA) | 1.49 |
| Ethylene-Vinyl Acetate (EVA) | 1.49 |
| Poly(vinyl alcohol) | 1.49-1.53 |
| Poly(ethyl glycolate methacrylate) | 1.4903 |
| Poly(3-methylcyclohexyl methacrylate) | 1.4947 |
| Poly(cyclohexyl.alpha.-ethoxyacrylate) | 1.4969 |
| Methyl cellulose (low viscosity) | 1.497 |
| Poly(4-methylcyclohexyl methacrylate) | 1.4975 |
| Poly(decamethylene glycol dimethacrylate) | 1.4990 |
| Poly(urethanes) | 1.5-1.6 |
| Poly(1,2-butadiene) | 1.5000 |
| Poly(vinyl formal) | 1.50 |
| Poly(2-bromo-4-trifluoromethylstyrene) | 1.5 |
| Cellulose nitrate | 1.50-1.514 |
| Polyethylene (LLDPE) | 1.50 |
| Polypropylene (PP) | 1.50 |
| Poly(sec-butyl.alpha.-chloroacrylate) | 1.500 |
| Poly(2-beptyl-1,3-butadiene) | 1.5000 |
| Poly(ethyl.alpha.-chloroacrylate) | 1.502 |
| Poly(2-isopropyl-1,3-butadiene) | 1.5028 |
| Poly(2-methylcyclohexyl methacrylate) | 1.5028 |
| Poly(propylene) (density 0.9075 g/cm.sup.3) | 1.5030 |
| Poly(isobutene) | 1.505-1.51 |
| Poly(bornyl methacrylate) | 1.5059 |
| Poly(2-tert-butyl-1,3-butadiene) | 1.5060 |
| Poly(ethylene glycol dimethacrylate) | 1.5063 |
| Poly(cyclohexyl methacrylate) | 1.5066 |
| Poly(cyclohexanediol-1,4-dimethacrylate) | 1.5067 |
| Butyl rubber (unvulcanized) | 1.508 |
| Poly(tetrahydrofurfuryl methacrylate) | 1.5096 |
| Gutta percha (5) | 1.509 |
| Poly(ethylene) ionomer | 1.51 |
| poly(oxyethylene) (high molecular weight | 1.51-1.54 |
| Poly(ethylene) (density 0.914 g/cm.sup.3) | 1.51 |
| (density 0.94-0.945 g/cm.sup.3) | 1.52-1.53 |
| (density 0.965 g/cm.sup.3) | 1.545 |
| Poly(1-methylcyclohexyl methacrylate) | 1.5111 |
| Poly(2-hydroxyethyl methacrylate | 1.5119 |
| Poly(vinyl chloroacetate) | 1.512 |
| Poly(butane)(isotactic) | 1.5125 |
| Poly(vinyl methacrylate) | 1.5129 |
| Poly(N-butyl-methacrylamide) | 1.5135 |
| Gutha percha (.alpha.) | 1.514 |
| Terpene resin | 1.515 |
| Poly(1,3-butadiene) | 1.5154 |
| Shellac | 1.51-1.53 |
| Poly(methyl.alpha.-chloroacrylate) | 1.517 |
| Poly(2-chloroethyl methacrylate) | 1.517 |
| Poly(2-diethylaminoethyl methacrylate) | 1.5174 |
| Poly(2-chlorocyclohexyl methacrylate) | 1.5179 |
| Poly(1,3-butadiene) (35% cis; 56% trans; 7% 1,2 | 1.5180 |
| content) | |
| Natural rubber | 1.519-1.52 |
| Poly(allyl methacrylate) | 1.5196 |
| Poly(vinyl chloride) + 40% dioctyl phthalate | 1.52 |
| Poly(acrylonitrile) | 1.52 |
| | 1.5187 |
| Poly(methacrylonitrile) | 1.52 |
| Poly(1,3-butadiene) (high cis-type) | 1.52 |
| Poly(butadiene-co-acrylonitrile | 1.52 |
| Poly(methyl isopropenyl icetone) | 1.5200 |
| Poly(isoprene) | 1.521 |
| Poly(ester) resin, rigid (ca, 50% styrene) | 1.523-1.54 |
| Poly(N-(2-methoxyethyl)methacrylamide) | 1.5246 |
| Poly(2,3-dimethylbutadiene) (methyl rubber) | 1.535 |
| Poly(vinyl chloride-co-vinyl acetate) (95/5-90/10) | 1.525-1.536 |
| Poly(acrylic acid) | 1.527 |
| Poly(1,3-dichioropropyl methacrylate) | 1.5270 |
| Poly(2-chloro-1-(chloromethyl)ethyl methacrylate) | 1.5270 |
| Poly(acrolein) | 1.529 |
| Poly(1-vinyl-2-pyrrolidone) | 1.53 |
| Hydrochlorinated rubber | 1.53-1.55 |
| Nylon 6: Nylon 6,6: Nylon 6, 10 (moulding) | 1.53 |
| (Nylon-6-fiber: 1.515 transverse. 1/565 in fiber | |
| direction) | |
| Poly(butadiene-co-styrene) (ca, 30% styrene) black | 1.53 |
| copolymer | |
| Ethylene/norbornene copolymer | 1.53 |
| Poly(cyclohexyl.alpha.-chloroacrylate) | 1.532 |
| Poly(butadiene-co-styrene) (ca, 75/25) | 1.535 |
| Poly(2-aminoethyl methacrylate) | 1.537 |
| Poly(furfuryl methacrylate) | 1.5381 |
| Proteins | 1.539-1.541 |
| Poly(1-phenyl-n-amyl methacrylate) | 1.5390 |
| Poly(N-methyl-methacrylamide) | 1.5398 |
| Cellulose | 1.54 |
| Poly(vinyl chloride) | 1.54-1.55 |
| Urea formaldehyde resin | 1.54-1.56 |
| Poly(sec-butyl.alpha.-bromoacrylate) | 1.542 |
| Poly(cyclohexyl.alpha.-bromoacrylate) | 1.542 |
| Poly(2-bromoethyl methacrylate) | 1.5426 |
| Poly(dihydroabietic acid) | 1.544 |
| Poly(abietic acid) | 1.546 |
| Poly(ethylmercaptyl methacrylate) | 1.547 |
| Poly(N-allyl methacrylamide) | 1.5476 |
| Poly(1-phenylethyl methacrylate) | 1.5487 |
| Poly(vinylfuran) | 1.55 |
| Poly(2-vinyltetrahydrofuran) | 1.55 |
| Poly(vinyl chloride) + 40% trictesyl phosphate | 1.55 |
| Epoxy resins | 1.55-1.60 |
| Poly(p-methoxybenyl methacrylate) | 1.552 |
| Poly(isopropyl methacrylate) | 1.552 |
| Poly(p-isopropylstyrene | 1/554 |
| Poly(chloroprene) | 1.554-1.558 |
| Poly(oxyethylene)-.alpha.-benzoate-.omega.- | 1.555 |
| methacrylate) | |
| Poly(p,p′-xylylenyl dimethacrylate) | 1.5559 |
| Poly(1-phenylallyl methacrylate) | 1.5573 |
| Poly(p-cyclohexylphenyl methacrylate) | 1.5575 |
| Poly(2-phenylethyl methacrylate) | 1.5592 |
| Poly(oxycarbonyloxy-1,4-phenylene-1-propyl | 1.5602 |
| butylidene- 1,4 phenylene | |
| Poly(oxycarbonyloxy-1,4-phenylene-1-propyl | 1.5624 |
| Poly(styrene-co-maleic anhydride) | 1.564 |
| Poly(1-phenylcyclohexyl methacrylate) | 1.5645 |
| Poly(oxycarbonyloxy-1,4-phenylene-1,3-dimethyl- | 1.5671 |
| butylidene-1,4phenylene | |
| Poly(methyl.alpha.-bromoacrylate) | 1.5672 |
| Poly(benzyl methacrylate) | 1.5680 |
| Poly(2-phenylsulfonyl)ethyl | 1.5682 |
| methacrylate)poly(m-cresyl methacrylate) | |
| Poly(styrene-co-acrylonitrile) (ca, 75/25) | 1.57 |
| Poly(ethylene terephthalate)(PET) | 1.57 |
| Poly(oxycarbonyloxy-1,4- | 1.5702 |
| phenyleleneisobutylidene-1,4-phenylene) | |
| Poly(o-methoxyphenyl methacrylate) | 1.5705 |
| Poly(phenyl methacrylate) | 1/5706 |
| Poly(o-cresyl methacrylate) | 1.5707 |
| Poly(diallyl phthalate) | 1.572 |
| Poly(2,3-dibromopropyl methacryate) | 1.5739 |
| Poly(oxycarbonyloxy-1,4-phenylene-1-methyl- | 1.5745 |
| butylidene-1,4-phenylene) | |
| Poly(oxy-2,6-dimethylphenylene) | 1.575 |
| Poly(oxyethyleneoxyterephthaloyl) | 1.5750 |
| (amorphous)(poly(ethylene terephthalate)) | |
| (crystalline fiber: 1.51 transverse; 1.64 in fiber | |
| direction | |
| Poly(vinyl benzoate) | 1.5775 |
| poly(oxycarbonyloxy-1,4-phenylenebutylidene- | 1.5792 |
| 1,4- phenylene) | |
| Poly(1,2-diphenylethyl methacrylate) | 1.5816 |
| Poly(o-chlorobenzyl methacrylate) | 1.5823 |
| Poly(oxycarbonyloxy-1,4-phenylene-sec- | 1.5827 |
| butylidene-1,4-phenylene | |
| Poly(oxypentaerythritoloxyphthaloyl) | 1.584 |
| Poly(m-nitrobenyl methacrylate) | 1.5845 |
| Poly(oxycarbonyloxy-1,4-phenyleneisopropylidene- | 1.5845 |
| 1,4-phenylene) | |
| Poly(N-2-phenylethyl)methacrylamide) | 1.5857 |
| Poly(4-methoxy-2-methylstyrene) | 1.5868 |
| Poly(o-methylstyrene) | 1.5874 |
| Poly(styrene) | 1.59-1.592 |
| Poly(oxycarbonyloxy-1,4- | 1.5900 |
| phenylenecyclohexylidene-1,4-phenylene) | |
| Poly(o-methoxystyrene) | 1.5832 |
| Poly(diphenylmethyl methacrylate) | 1.5933 |
| Poly(oxycarbonyloxy-1,4-phenyleneethylidene- | 1.5937 |
| 1,4-phenylene) | |
| Poly(p-bromophenyl methacrylate) | 1.5964 |
| Poly(N-benzyl methacrylamide) | 1.5965 |
| Poly(p-methoxystyrene) | 1.5967 |
| Hard rubber (32% S) | 1.6 |
| Poly(vinylidene chloride) | 1.60-1.63 |
| Poly(sulfides (“Thiokol”)) | 1.6-1.7 |
| Poly(o-chlorodiphenylmethyl methacrylate) | 1.6040 |
| Poly(oxycarbonyloxy-1,4-(2,6-dichloro)phenylene- | 1.6056 |
| isopropylidene-1,4-(2,6-dichloro)phenylene)) | |
| Poly(oxycarbonyloxybis(1,4-(3,5-dichiorophenylene)) | 1.6056 |
| Poly(pentachiorophenyl methacrylate) | 1.608 |
| Poly(o-chlorostyrene_{—} | 1.6098 |
| Poly(phenyl.alpha.-bromoacrylate) | 1.612 |
| Poly(p-divinylbenzene) | 1.6150 |
| Poly(ethylene naphthalate) (PEN) | 1.64 |

The multilayer films are usually made by a chill-roll casting technique in which melts of the thermoplastic resinous material from two or more extruders are collected by a feedblock which arranges them into a desired layered pattern. The very narrow multilayer stream flows through a single manifold flat film die with the layers simultaneously spread to the width of the die and thinned to the final die exit thickness. The number of layers and their thickness distribution can be changed by using a different feedblock module. Suitable feedblocks are described, for instance, in U.S. Pat. Nos. 3,565,985 and 3,773,882. The feedblocks can be used to form alternating layers of either two components (i.e. ABAB . . . ); three components (ABCABCA . . . or ACBACBC . . . ) or more. Usually, the outermost layer or layers on each side of the sheet is thicker than the other layers so as to form a relatively thick skin. The resinous material used to form the skin may be one of the components which makes up the optical core, or a different polymer which is utilized to impart a desirable mechanical, heat sealing or other property, or a combination of these. Preferably, the present film is made by a process disclosed in U.S. Pat. No. 3,801,429, incorporated herein by reference. The films of this invention may be oriented uniaxially in any direction or biaxially using conventional equipment.

For certain applications it is desireable to modify the optical effect of the targeted wavelengths. Separating the optical polymer stack of a conventional iridescent film and inserting a discrete polymer stream in between can failitate a range of unique effects. The inserted layer, which is sandwiched between at least two stacked layers of alternating pairs of polymers which generate iridescence, may contain one or more additives which can be tailored to augment and modify the usual optical effect. A new effect film can be produced whereby the maximized reflection color attainable via lamination to opaque or colored substrates can be produced by incorporating pigments, dyes or other light influencing substances compounded into a polymer which is extruded between the conventional layers of polymer pairs. Typically, about 0.5 to about 40 percent by weight of particulate additive relative to the weight of the polymer may be included in the inserted layer.

At least one interior functional or optical effect layer is present in the iridescent film of this invention. The polymer selected for the interior layer will depend upon the desired functionality or optical effect to be achieved. The polymers used for the optical stack layers may also be used for the interior layer in different thicknesses and/or containing different effect materials. If more than one interior functional or optical effect layer is present, such layer can be contiguous to another interior functional or optical effect layer or sandwiched between sets of core layers.

The term “optical effect” as used herein means imparting a property to the film which alters the appearance of reflected and/or transmitted visible or ultraviolet or infrared light.

The different optical effect materials which can be added to the interior layer of the present invention may have any morphology including platelet, spherical, cubical, acicular, whiskers, or fibrous. Examples of useful platy materials include play metals or metal oxides and the like, such as, for example, platy aluminum oxide, platy glass, aluminum, mica, bismuth oxychloride, platy iron oxide, platy graphite, platy silica, bronze, stainless steel, natural pearl, boron nitride, silicon dioxide, copper flake, copper alloy flake, zinc flake, zinc alloy flake, zinc oxide, enamel, china clay, and porcelain and the like. Within the exterior skin layer, a mixture of morphologies or materials or both may be used. Glass flakes have the attributes of high transparency, very white bulk color and a sparkle effect in strong light.

Examples of useful spherical materials include glass, plastic, ceramic, metal, or an alloy and the spheres may be solid or hollow. Useful glass spheres are disclosed in U.S. Pat. No. 5,217,928, incorporated in its entirety herein by reference. Useful commercial ultrafine glass microspheres are commercially available from Engelhard Corporation and include Prizmalite® P2011SL ultrafine glass microspheres (They are clear solid glass microspheres with a 4-micron mean diameter, a tight distribution, and a top size of 13 microns.).

Useful cubical material includes glass cubes.

Glass can be classified for example as A glass, C glass, E glass, and ECR glass and are detailed in the following Table 2.

TABLE 2

| TYPE | A GLASS | C GLASS | E GLASS | E GLASS |
|---|---|---|---|---|
| SiO₂ | 72.5 | 65-70 | 52-56 | 52.5 |
| Al₂O₃ | 0.4 | 2-6 | 12-16 | 14.5 |
| CaO | 9.8 | 4-9 | 20-25 | 22.5 |
| MgO | 3.3 | 0-5 | 0-5 | 1.2 |
| B₂O₃ | 0.0 | 2-7 | 5-10 | 8.6 |
| Na₂ + K₂O | 5.8 | 9-13 | <0.8 | <0.5 |
| ZnO | — | 1-6 | — | — |
| FeO/Fe₂O₃ | 0.2 | — | — | 0.2 |

Other glass types include quartz glass and glass composition having a softening point of ≧800° C., e.g. Schott Duran or Supremax types. The softening point is defined, according to ASTM C 338 as the temperature at which a uniform fiber of glass with a diameter of 0.55-0.75 mm and a length of 23.5 cm increases its length by 1 mm./min when the upper 10 cm. is heated at a rate of 5° C./min.

The term “functional” as used herein means providing a physical effect distinct from an optical effect such as 1) providing moisture, oxygen, or aroma barrier, 2) providing thermal insulation, or any of a wide array of useful physical or mechanical functions needed when the film is utilized in a specific manner.

In accordance with the present invention, a third extruder feeds polymer into the center between optical stacks of alternating polymers. Ideally a fourth and possibly fifth extruder delivers the same or different polymer stream to provide a different function or effect for the exterior surfaces of the film.

The films of the present invention may be used in flexible and rigid decorative packaging. Flexible decorative packaging includes but is not limited to wrapping paper, ribbons, and bows. Rigid decorative packaging includes but is not limited to cosmetic and personal care containers such as for skin care products such as facial mask, UV protective lotion, liquid soap, and antimicrobial product; hair care products such as shampoo, conditioner, hair spray or fixative, and hair colorant; makeup products such as nail polish, mascara, eye shadow, and perfume; shaving cream, deodorant, and baby oil. The present film may also be used in printed and laminated board for use in packaging. The present invention may also be used in graphic applications such as book covers. The present film may also be used in fashion accessories such as sequins and threads. The present film may also be used in picture frame profile wrapping.

Additionally, the films of the present invention may be reduced in size in some manner to form glitter particles. These particles can be made of various sizes and shapes depending on the application. The size, for example, can range from very small, approximately 0.002″ and preferably 0.004″, to larger particles.

The present film may also be used as a label for various containers. Such containers include but are not limited to cosmetic and personal care containers such as for skin care products such as facial mask, UV protective lotion, liquid soap, and antimicrobial product; hair care products such as shampoo, conditioner, hair spray or fixative, and hair colorant; makeup products such as nail polish, mascara, eye shadow, and perfume; shaving cream, deodorant, and baby oil. The present invention may also be used on a colored substrate including a transparent container filled with colored liquid.

### INVENTIVE EXAMPLES 1-5

Iridescent films were made having the properties described in the following Table 3.

TABLE 3

| | | OPTICAL POLYMER |
|---|---|---|
| INVENTIVE | CENTRAL CORE LAYER | STACK |
| EXAMPLE | MATERIALS | (113 layers × 2) |
| 1 | PBT | PET/PMMA |
| 2 | PBT + 1% carbon black | PET/PMMA |
| 3 | PBT + 3% TiO₂ | PET/PMMA |
| 4 | PBT + 4% Blue organic | PET/PMMA |
| | pigment | |
| 5 | PBT + 3% 2100 mica | PET/PMMA |

What is claimed is:

1. An optical effect thermoplastic resinous laminate film of at least 10 very thin layers of substantially uniform thickness, said layers being generally parallel, the contiguous adjacent layers differing in refractive index by at least about 0.03, said film containing an interior layer being generally parallel with said contiguous adjacent layers and being different from said contiguous adjacent layers, said film containing at least one pair of said contiguous adjacent layers on both sides of said interior layer.

2. The optical effect film of claim 1 having at least about 35 layers.

3. The optical effect film of claim 2 having at least about 70 layers.

4. The optical effect film of claim 1 wherein said contiguous adjacent layers differ in refractive index by at least about 0.06.

5. The optical effect film of claim 1 wherein said interior layer is of a different thermoplastic material than either of said contiguous adjacent layers.

6. The optical effect film of claim 1 wherein said interior layer has physical properties different from either of said contiguous adjacent layers.

7. The optical effect film of claim 1 wherein said interior layer contains particulate materials which provide said interior layer with a different optical effect than said contiguous adjacent layers.

8. The optical effect film of claim 7 wherein said particulate material is in the form of platelets, spheres, cubes, whiskers, or fibers.

9. The optical effect film of claim 8 wherein said interior layer contains platy material.

10. The optical effect film of claim 8 wherein said interior layer contains a pigment.

11. The optical effect film of claim 10 wherein said pigment is carbon black, a metal oxide, or an organic pigment.

12. The optical effect film of claim 1 wherein one of said contiguous adjacent layers is a polyester.

13. The optical effect film of claim 12 wherein said polyester is polyethylene terephthalate, polybutylene terephthalate, or polyethylene naphthalate.

14. The optical effect film of claim 13 wherein the other of said contiguous adjacent layers is polymethyl methacrylate.

15. The optical effect film of claim 1 comprising a skin layer on the outer most top and bottom of said film, each of said skin layers comprising at least about 5% of the total thickness of said film.

16. The optical effect film of claim 1 containing a sufficient quantity of a stable transparent dye which is soluble in the thermoplastic resinous material of the layers in which it is located to enhance or modify the apparent color of at least one of the reflection and/or transmission colors of the film.

17. The optical effect film of claim 1 containing a plurality of said interior layers.

18. The optical effect film of claim 17 wherein at least two of said interior layers are contiguous with each other.

19. The optical effect film of claim 17 wherein each of said interior layers contains at least one pair of said contiguous adjacent layers on both sides of said interior layers.

20. The optical effect film of claim 18 wherein at least one of said contiguous interior layers contains particulate materials which provide said at least one interior layer with a different optical effect than said contiguous layers.
